(19) United States
(12) Patent Application Publication
(10) Pub. No.: US 2009/0128982 A1
(43) Pub. Date: May 21, 2009

(54) STATIC ELECTRICITY ELIMINATING APPARATUS AND ELECTRONIC APPARATUS

(75) Inventor: Jun OSHIMA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/271,339

(22) Filed: Nov. 14, 2008

(30) Foreign Application Priority Data
Nov. 20, 2007 (JP) 2007-300835

(51) Int. Cl. H02H 1/00

(52) U.S. Cl. 361/212

(57) ABSTRACT

A static electricity eliminating apparatus for eliminating static electricity which has built up on a medium, e.g., card-shaped that may be inserted into and removed from an opening of a card loading body is provided. The static electricity eliminating apparatus includes a housing having an opening through which the medium may be inserted and removed. The apparatus includes a conductive member with one end fixed to the housing, and the other end that extends over the opening so as to block the insertion-and-removal opening, and which eliminates static electricity which has built up on the medium by contacting the medium when the medium is inserted into the insertion-and-removal opening.

### CROSS-REFERENCE TO RELATED APPLICATIONS

This application is related to and claims priority to Japanese patent application No. 2007-300835 filed on Nov. 20, 2007, in the Japan Patent Office, and incorporated by reference herein.

### BACKGROUND

1. Field

The embodiments discussed herein are directed to a static electricity eliminating apparatus and an electronic apparatus, and a static electricity eliminating apparatus and an electronic apparatus capable of eliminating static electricity from a medium, e.g., card-shaped medium that is removable from a slot.

2. Description of the Related Art

Some electronic devices such as a personal computer have a slot into which a card or a medium can be inserted. A card or a medium may build up static electricity. It is known that, when such a card, for example, a personal computer (PC) card, is inserted into an electronic device, the static electricity that has built up on the card may discharge and adversely affect electronic components and within the electronic device.

Thus, an apparatus and method are needed to eliminate static electricity that has built up on a card or medium to be inserted therein.

### SUMMARY

It is an aspect of the embodiments discussed herein to provide a static electricity eliminating apparatus for eliminating static electricity.

It is an aspect of an exemplary embodiment discussed herein to provide a static electricity eliminating apparatus and an electronic apparatus capable of preventing foreign matter from entering an opening while reducing the number of parts used.

The above aspects can be attained by a static electricity eliminating apparatus for eliminating static electricity which has built up on a medium, e.g, card-shaped that is inserted into and removed from an insertion-and-removal opening of a card loading body for the insertion and removal of a medium, e.g., card-shaped, the static electricity eliminating apparatus including a housing on which an opening is formed, the medium, e.g., card-shaped being caused to pass through the opening at the time of the insertion and removal of the medium, e.g., card-shaped, and a conductive member whose one end is fixed to the housing, whose other end extends over the insertion-and-removal opening so as to block the insertion-and-removal opening, and which eliminates static electricity which has built up on the medium, e.g., card-shaped by contacting the medium, e.g., card-shaped when the medium, e.g., card-shaped is inserted into the insertion-and-removal opening.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates an electronic apparatus including a static electricity eliminating apparatus according to an exemplary embodiment;

FIG. 2 illustrates a partial enlarged front view of a static electricity eliminating apparatus according to an exemplary embodiment of this technology;

FIG. 3A is a sectional view illustrating a static electricity eliminating apparatus according to an exemplary embodiment before a medium inserted;

FIG. 3B is a sectional views illustrating a static electricity eliminating apparatus according to an exemplary embodiment while a medium is inserted;

FIG. 4A is a sectional view illustrating a static electricity eliminating apparatus according to an exemplary embodiment before a medium inserted;

FIG. 4B is a sectional view illustrating a static electricity eliminating apparatus according to an exemplary embodiment while a medium is inserted.

### DETAILED DESCRIPTION OF THE EMBODIMENTS

Reference will now be made in detail to exemplary embodiments, examples of which are illustrated in the accompanying drawings, wherein like reference numerals refer to the like elements throughout. The embodiments are described below to explain the present invention by referring to the figures.

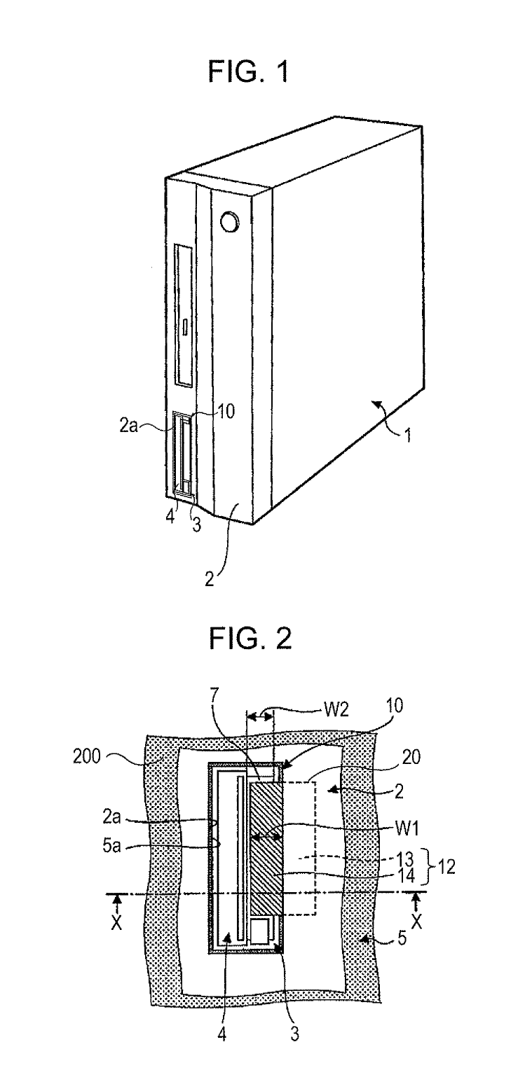

FIG. 1 through FIGS. 3A and 3B illustrate a static electricity eliminating apparatus 10 according to an exemplary embodiment. Each of the drawings illustrates an example in which a static electricity eliminating apparatus 10 is installed in an electronic apparatus 1 (e.g., a personal computer).

As illustrated in FIG. 1, a PC card slot 3 and a slot 4 for a card based on the reception method established by BS Conditional Access Systems Co., Ltd. (B-CAS) (hereinafter the slot 4 being referred to as a “B-CAS card slot 4”) are arranged in an opening 2a formed on a front panel 2 of the electronic apparatus 1. As illustrated in an enlarged view in FIG. 2, this PC card slot 3 includes an opening 5a formed on a housing 5 and a PC card reader, i.e., card-loading body that may be arranged so as to face this opening 5a. The PC card reader includes an opening 7 for the insertion and removal of a card such as a PC card (hereinafter the opening 7 being referred to as an “insertion-and-removal opening 7”) and which faces the openings 2a and 5a, and a PC card, i.e., medium, e.g., card-shaped may be inserted into and removed from the insertion-and-removal opening 7 via the openings 2a and 5a.

The housing 5 may be formed of a conductive metal, and positioned inside the front panel 2. This housing 5 may be grounded, and thus serve as a shield for a circuit or an apparatus arranged in the housing 5.

A conductive member 12 may be conductive fabric tape in an exemplary embodiment. The conductive fabric tape hay be conductive fibers weaved in a fabric shape, the conductive fibers being made by plating fabric fibers made of, for example, polyethylene terephthalate (PET) with a conductive metal (for example, copper or the like).

Since this conductive fabric tape has flexibility, this conductive fabric tape imam be used as the conductive member 12, whereby the PC card can be prevented from being damaged by contacting the conductive member 12 when the PC card is inserted into the insertion-and-removal opening 7. Moreover, since the conductive fabric tape has elasticity, when the PC card is inserted, the conductive member 12 contacts the PC card with an elastic force. Thus, the conductive member 12 and the PC card may reliably and electrically be connected. Here, the material of the conductive member 12 is not limited to the above-described conductive fabric taper and other materials such as a conductive rubber can also be utilized.

This conductive member 12 is fixed to the housing 5 using, for example, a conductive adhesive. Thus, with the conductive member 12 fixed to the housing 5, the conductive member 12 and the housing 5 are electrically connected, whereby the conductive member 12 is also in a grounded state.

With respect to the conductive member 12, a region 20 indicated by broken lines in FIG. 2 is a region which is fixed to the housing 5 using a conductive adhesive or the like (hereinafter the region being referred to as a “fixed portion 13”). Moreover, with respect to the conductive member 12, a region 200 which is hatched in FIG. 2 is a region extending from the fixed portion 13 to a position facing the insertion-and-removal opening 7 (hereinafter the region being referred to as a “cover portion 14”). Thus, the conductive member 12 has a configuration in which the fixed portion 13, which is one end thereof is fixed to the housing 5 and the cover portion 14, which is the other end thereof, extends over the insertion-and-removal opening 7 and may have a cantilever shape.

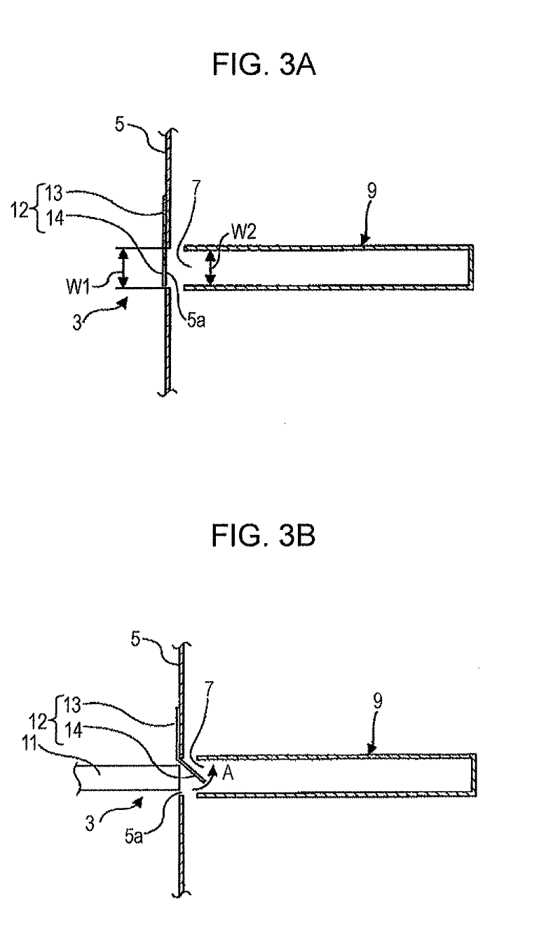

Moreover, the length of the cover portion 14 extending from the fixed portion 13 (hereinafter referred to as the width W1) is greater than or equal to the width W2 of the insertion-and-removal opening 7 (W1>W2). With this configuration, as illustrated in FIG. 3A, the conductive member 12 may be positioned like a wall toward the front of the insertion-and-removal opening 7 of the PC card reader 9, and the insertion-and-removal opening 7 is substantially blocked by the cover portion 14 (the conductive member 12). Here, the substantially blocked state is a state in which the cover portion 14 (the conductive member 12) does not have a configuration to directly close the insertion-and-removal opening 7 but prevents foreign matter from entering the inside of the insertion-and-removal opening 7 via the opening 5a.

Next, the operation of static electricity eliminating apparatus 10 having the configuration described above will be described with reference to FIGS. 3A and 3B. FIGS. 3A and 3B show a section of FIG. 2 taken along alternate-long-and-short-dash line X-X. Here, for convenience in terms of illustration, FIGS. 3A and 3B illustrate the housing 5 and the PC card reader 9 in different orientation than FIG. 2.

FIG. 3A illustrates the PC card slot 3 before the insertion of a PC card 11. As described above, the cover portion 14 of the conductive member 12 extends by the width W1, which is greater than or equal to the width W2 of the insertion-and-removal opening 7, and substantially blocks the insertion-and-removal opening 7. Thus, even if foreign matter tries to enter the insertion-and-removal opening 7, the cover portion 14 (the conductive member 12) prevents the foreign matter from entering therein. Because of this, foreign matter can be prevented from entering the PC card reader 9.

FIG. 3B illustrates a state in which the PC card 11 has been inserted into the PC card slot 3. As illustrated in FIG. 3B, when the PC card 11 is inserted toward the right in the drawing, the PC card 11 contacts the conductive member 12 constituted by a conductive fabric tape, and is loaded into the PC card reader 9 while elastically deforming the conductive member 12 in the direction indicated by arrow A.

The contact between the conductive member 12 and the PC card 11 may cause static electricity which has built up on the PC card 11 to discharge to the housing 5 which is grounded via the conductive member 12 having conductivity. As a result, the PC card 11 may be discharged. Moreover, in an exemplary embodiment, the width W1 by which the cover portion 14 extends toward the insertion-and-removal opening 7 is longer than that of an existing cover portion, resulting in a large contact area between the PC card 11 and the conductive member 12. Thus, the PC card 11 can assuredly be discharged.

Moreover, in an exemplary embodiment, in a state in which the PC card 11 is not inserted, the insertion-and-removal opening 7 of the PC card reader 9 is always caused to be in the substantially blocked state by the cover portion 14 (the conductive member 12). Thus, when the electronic apparatus 1 having the PC card slot 3 is shipped from a factory, there is no need to provide a dummy card 108 for preventing foreign matter from entering the PC card slot 3, and a fastening tape 115 for preventing this dummy card 108 from popping out of the PC card slot 3. Thus, the number of parts used and manufacturing steps for assembly can be reduced, whereby the cost of the electronic apparatus 1 can be reduced.

In the static electricity eliminating apparatus 10 having the above-described configuration, since the conductive member 12 is constituted by just a conductive fabric tape, the conductive fabric tape may deteriorate with time because of the insertion and removal of the PC card 11 and may not return to its original position but remain bent in the direction indicated by arrow A. In this case, similarly to an existing way, the insertion-and-removal opening 7 is in a state equivalent to the state in which the insertion-and-removal opening 7 is open to the outside, and foreign matter may enter thereinto.

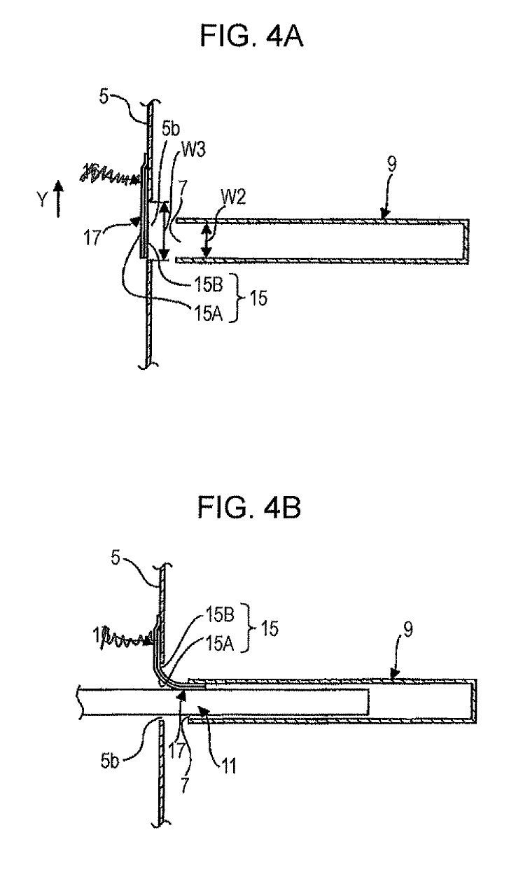

FIG. 4 illustrates a static electricity eliminating apparatus according to an exemplary embodiment, and has a configuration capable of overcoming the above-described problem. In the exemplary embodiment, a conductive member 15 includes a conductive fabric tape 15A and a flexible sheet 15B, and the width W3 of a cover portion 17 may be arranged to be wider than the width W2 of the insertion-and-removal opening 7.

The conductive fabric tape 15A may be made of the same material as the conductive member 12 described in the first exemplary embodiment, and has a configuration in which conductive fibers are weaved in a fabric shape. The flexible sheet 15B is a resin sheet made of, for example, PET or the like. This flexible sheet 15B and the conductive fabric tape 15A are bonded using an adhesive or by thermocompression bonding. Here, the conductive fabric tape 15A may be arranged on the front (external) side of the conductive member 15, and the flexible sheet 15B may be arranged on a side facing the insertion-and-removal opening 7.

In this way, since the conductive member 15 has a configuration in which the conductive fabric tape 15A and the flexible sheet 15B are stacked, the conductive fabric tape 15A is reinforced with the flexible sheet 15B, whereby the conductive member 15 can be prevented from deteriorating with time. Moreover, since the flexible sheet 15B is a thin sheet-like member as described above, even if the conductive member 15 has a multilayer structure in which the conductive fabric tape 15A and the flexible sheet 15B are stacked, the flexible sheet 15B does not adversely affect the insertion-and-removal operation of the PC card 11 when the PC card 11 is inserted into and removed from the insertion-and-removal opening 7.

Moreover, in the second exemplary embodiment, the width W3 of the cover portion 17 may be arranged to be wider than the width W2 of the insertion-and-removal opening 7. Here, an opening 5b formed on the housing 5 is formed to be wider in the direction opposite the direction in which the cover portion 17 extends (the direction indicated by arrow Y in FIG. 4A), and thus the width W3 of the cover portion 17 may be arranged to be wider than that in an exemplary embodiment (see FIG. 3A)

With this configuration, a clearance having a width of (W3-W2) is formed on the side of the PC card reader 9 in the direction indicated by arrow Y. The formation of this clearance allows the conductive member 15 to elastically deform in a bent shape as illustrated in FIG. 4B when the PC card 11 is inserted. Thus, stress is not concentrated at a particular portion of the conductive member 15, whereby the occurrence of the deterioration of the conductive member 15 with time can be suppressed.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A static electricity eliminating apparatus for eliminating static electricity which has built up on a medium that is inserted into and removed from an insertion-and-removal opening of a loading body for the insertion and removal of a medium, the static electricity eliminating apparatus comprising:
a housing on which an opening is formed, the medium being caused to pass through the opening at the time of the insertion and removal of the medium; and
a conductive member whose one end is fixed to the housing, whose other end extends over the insertion-and-removal opening so as to block the insertion-and-removal opening, and which eliminates static electricity which has built up on the medium by contacting the medium when the medium is inserted into the insertion-and-removal opening.

2. The static electricity eliminating apparatus according to claim 1,
wherein the conductive member is a member made by bonding a conductive fabric tape and a flexible sheet.

3. The static electricity eliminating apparatus according to claim 1,
wherein the conductive fabric tape is made by weaving resin fabrics and a conductive metal thin line.

4. The static electricity eliminating apparatus according to claim 2,
wherein the conductive member is made so that the conductive fabric tape is arranged on a front side thereof and the flexible sheet is arranged on a side facing the insertion-and-removal opening.

5. The static electricity eliminating apparatus according to claim 1,
wherein the housing is made of a conductive metal.

6. The static electricity eliminating apparatus according to claim 1,
wherein the medium is a PC card.

7. An electronic apparatus comprising:
the static electricity eliminating apparatus according to claim 1.

8. A static electricity eliminating apparatus comprising:
a housing having an opening through which at least part of a medium may be inserted and removed;
a conductive member having one end is fixed to the housing and another end extendable over the opening so as to block the opening and contact part of the medium.

9. A method of eliminating static electricity static electricity which has built up on a medium that is inserted into and removed from an opening in an electronic apparatus, the method comprising:
inserting a medium into an apparatus; and
contacting a part of the medium with a conductive member, the conductive medium having one end fixed to the housing and another end capable of blocking part of the opening.
